(19) United States
(12) Patent Application Publication
(10) Pub. No.: US 2026/0283295 A1
(43) Pub. Date: Sep. 24, 2026

(54) MODULE COMPONENT FOR SHOES AND CLOTHING, SOLE COMPONENT, AND LUMINOUS SPORTS SHOES

(71) Applicant: SINCETECH (FUJIAN) TECHNOLOGY CO., LTD., Quanzhou (CN)

(72) Inventors: Qinglai CAI, Quanzhou (CN); Jintai XU, Quanzhou (CN); Xianzhao GUO, Quanzhou (CN); Hao YI, Quanzhou (CN); Yugang CHEN, Quanzhou (CN)

(21) Appl. No.: 18/723,702

(22) PCT Filed: May 5, 2023
(86) PCT No.: PCT/CN2023/092380

§ 371 Date: Sep. 26, 2025

(30) Foreign Application Priority Data
May 4, 2022 (CN) 202221044538.9
Jun. 18, 2022 (CN) 202221535700.7
Jul. 28, 2022 (CN) 202221975334.7
Dec. 30, 2022 (CN) 202223601410.0

(51) Int. Cl. A43B 3/36; A41D 27/08; A43B 3/40; A43B 5/00; F21S 4/28; F21S 9/02; F21V 8/00; F21V 19/00; F21V 23/06

(52) U.S. Cl. CPC A43B 3/36; A41D 27/085; A43B 3/40; A43B 5/00; F21S 4/28; F21S 9/02; F21V 19/004; F21V 23/06; G02B 6/001

(57) ABSTRACT

The present application relates to a field of shoes and clothing technologies and discloses a module component for shoes and clothing, a sole component, and luminous sports shoes. The module component includes a stitching piece, a connecting piece, a module, where the module is connected to the stitching piece by the connecting piece, the stitching piece is connected on the shoes and clothing in a snap-fitted manner, and the module is a luminous module or a vibration module. By optimizing the setting of the module, the vibration module is easily connected and combined by the stitching piece and the connecting piece, the installation is simple, and the connection and matching effect is good.

### TECHNICAL FIELD

The present application relates to a field of shoes and clothing technologies, and in particular, to a module component for shoes and clothing, a sole component, and luminous sports shoes.

### BACKGROUND

Nowadays, when people buy shoes, they no longer just consider the aesthetics of the shoes, but also focus on the functionality of the shoes. Ordinary shoes have been difficult to meet the using needs. Therefore, there is a need for shoes in which modules can be replaced for functional replacement. In the prior art, shoe bodies have a single structure, without a good using effect.

### SUMMARY

An objective of the present application is to provide a module component for shoes and clothing, a sole component, and luminous sports shoes to solve the above-mentioned problems.

The present application discloses a module component for shoes and clothing, comprising a stitching piece, a connecting piece, a module, where the module is connected to the stitching piece by the connecting piece, the stitching piece is connected onto the shoes and clothing in a snap-fitted manner, and the module is a luminous module or a vibration module.

Preferably, the luminous module includes a wrapping shell, a light strip, a circuit board, a control switch, a first charging port, and a first battery; the control switch and the first charging port are soldered onto the circuit board; an edge of the wrapping shell is connected to the light strip; and the first battery is electrically connected to the light strip.

Preferably, the vibration module includes the circuit board, the control switch, the first charging port, the first battery, and vibration units, where the control switch and the first charging port are soldered onto the circuit board, and the first battery is electrically connected to the vibration units.

The present application further discloses a sole component, comprising a sole, where the module component is provided at a heel of the sole.

The present application further discloses luminous sports shoes, where each luminous sports shoe includes:
A shoe upper;
A sole, the shoe upper being connected to the sole;
An elastic module, provided on the shoe upper;
The module component, located at a heel of the sole; and
A luminous component, comprising an optical fiber connected to the module component.

Preferably, the luminous component further includes a switch charging piece, a wire, a power supply chip piece, and an optical fiber that are provided in the module component, where the switch charging piece is electrically connected to the power supply chip piece with the wire; the power supply chip piece is electrically connected to the optical fiber; and the optical fiber is fixed onto the shoe upper.

Preferably, the shoe upper is provided with a densely woven region and a sparse region, and the optical fiber passes through the densely woven region and the sparse region.

Preferably, the sparse region is distributed in a mesh pattern on an outer surface of the optical fiber.

Preferably, the switch charging piece is provided with a switch button and a second charging port.

Preferably, the control chip piece is provided with a control chip and a second battery; the second charging port converts electrical energy into chemical energy and stores the chemical energy in the second battery via a data cable; and the second battery converts the chemical energy into electrical energy to power on the optical fiber to emit light.

Preferably, at least one optical fiber is provided.

Preferably, an entire optical fiber is provided around an edge of the sports shoe.

Preferably, the sole includes:
A midsole, connected to the shoe upper, the midsole being hollow inside and being of a transparent material, a luminous strip connected to a power supply chip piece being provided in the midsole, a plurality of upper protrusions and a plurality of lower protrusions being provided in the midsole, the upper protrusions being opposite to the lower protrusions, and the protrusions being connected; and
An outsole, provided at a bottom of the midsole, the bottom of the outsole being provided with a plurality of damping protrusions, and the outsole being provided with a plurality of irregular-shaped holes.

Preferably, the damping protrusion is circular or elliptical.

Preferably, surfaces of the damping protrusions are each provided with a plurality of grooves.

Preferably, the luminous strip is provided in a straight line from a forefoot to a heel of the midsole.

Preferably, a surface of the midsole is further provided with a mounting groove, a plurality of communication grooves communicated with the interior of the midsole are provided in the mounting groove, and a light bar connected to the power supply chip piece is provided in the mounting groove.

Preferably, the light bar includes a bar body and a plurality of light beads spaced on the bar body, and each of the light beads is located in a corresponding communication groove.

Preferably, at least two light beads have different luminous colors.

One or more technical solutions provided by the present application at least have the following technical effects: by optimizing the setting of the module, the vibration module is easily connected and combined by the stitching piece and the connecting piece, the installation is simple, and the connection and matching effect is good. By optimizing the settings of the luminous module and the vibration module, a user can flexibly replace them according to his/her usage needs. Internal structures of the modules are simple, and the modules can be controlled by a control switch to be turned on and off. A first charging port stores electric power for a first battery, and the usage needs are met by core parts such as a light strip and vibration units.

### BRIEF DESCRIPTION OF THE DRAWINGS

To explain the technical solutions in the embodiments of the present application more clearly, a brief introduction will be made to the accompanying drawings required in the embodiments or the description of the prior art below. Obviously, the accompanying drawings in the following description are only some embodiments of the present application. For those skilled in the art, other accompanying drawings can be obtained from these accompanying drawings without any creative effort.

FIG. 1 is a structural schematic diagram of a luminous module of a sports shoe according to Embodiment 1 of the present application;

FIG. 2 is a structural schematic diagram of a vibration module of a sports shoe according to Embodiment 1 of the present application;

FIG. 3 is a schematic diagram of an internal structure of a luminous module according to Embodiment 1 of the present application;

FIG. 4 is a schematic diagram of an internal structure of a vibration module according to Embodiment 1 of the present application;

FIG. 5 is a schematic diagram of a module mounting structure of a sports shoe according to Embodiment 2 of the present application;

FIG. 6 is a structural schematic diagram of a sports shoe according to Embodiment 3 of the present application;

FIG. 7 is a structural schematic diagram of a luminous component in a sports shoe according to Embodiment 3 of the present application;

FIG. 8 is a structural schematic diagram of a bottom of a sole of a sports shoe according to Embodiment 3 of the present application;

FIG. 9 is a structural schematic diagram of a surface of a midsole of a sports shoe according to Embodiment 3 of the present application; and

FIG. 10 is a schematic diagram of a distribution structure of a light bar of a sports shoe according to Embodiment 3 of the present application.

Main reference numerals: 1. Shoe upper; 2. Sole; 21. Midsole; 22. Outsole; 3. Elastic module; 4. Vibration unit; 5. Luminous component; 51. Switch charging piece; 511. Switch button; 512. Second charging port; 52. Wire; 53. Power supply chip piece; 531. Control chip; 532. Second battery; 54. Optical fiber; 551. Densely woven region; 552. Sparse region; 6. Luminous strip; 7. Damping protrusion; 8. Irregular-shaped hole; 9. Groove; 10. Module; 101. Wrapping shell; 11. Connecting piece; 12. Stitching piece; 13. Stitching opening; 14. Mounting groove; 15. Communication groove; 16. Light bar; 161. Bar body; 162. Light bead; 17. Upper protrusion; 18. Lower protrusion; 19. Light strip; 20. Circuit board; 21. Control switch; 22. First charging port; and 23. First battery.

### DETAILED DESCRIPTION

Embodiments of the present application will be described in detail below, and examples of the embodiments are shown in the accompanying drawings, where the same or similar reference signs throughout the description indicate the same or similar element or elements having the same or similar function. The embodiments described below with reference to the accompanying drawings are exemplary and intended to explain the embodiments of the present application but cannot be understood as limiting the present application.

In the description of the embodiments of the present application, it should be understood that the orientation or positional relationship indicated by the terms “length”, “width”, “up”, “down”, “front”, “back”, “left”, “right”, “vertical”, “horizontal”, “top”, “bottom”, “inside”, “outside” and the like is based on the orientation or positional relationship shown in the attached drawings, which is only for the convenience of describing the embodiments of the present application and simplifying the description, but not for indicating or implying that the apparatus or element referred to must have a specific orientation, be constructed and operated in a specific orientation, which therefore cannot be understood as a restriction on the present application.

Furthermore, the terms “first” and “second” are only used for descriptive purposes and cannot be understood as indicating or implying relative importance or implying the number of technical features indicated. Thus, the features defined as “first” and “second” may include one or more features explicitly or implicitly. In the description of the embodiments of the present application, “a plurality of” means two or more, unless otherwise explicitly and specifically defined.

### Embodiment 1

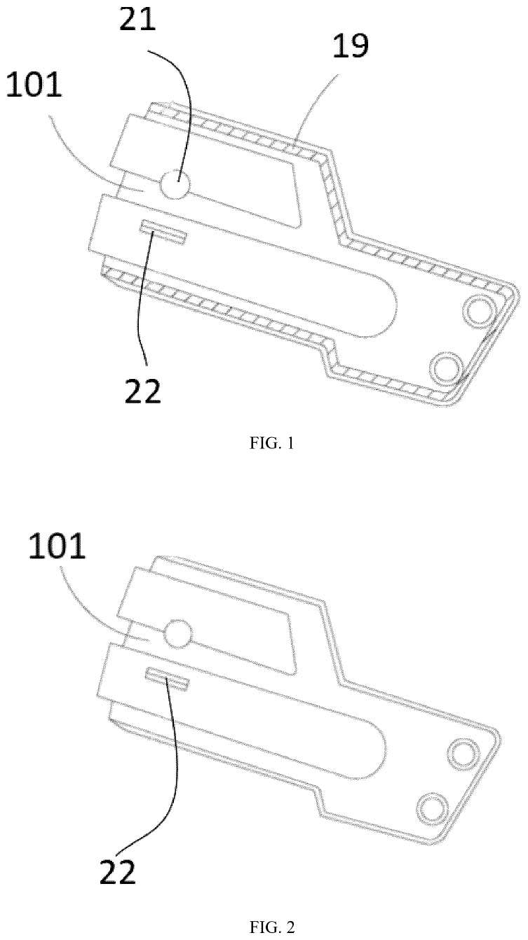

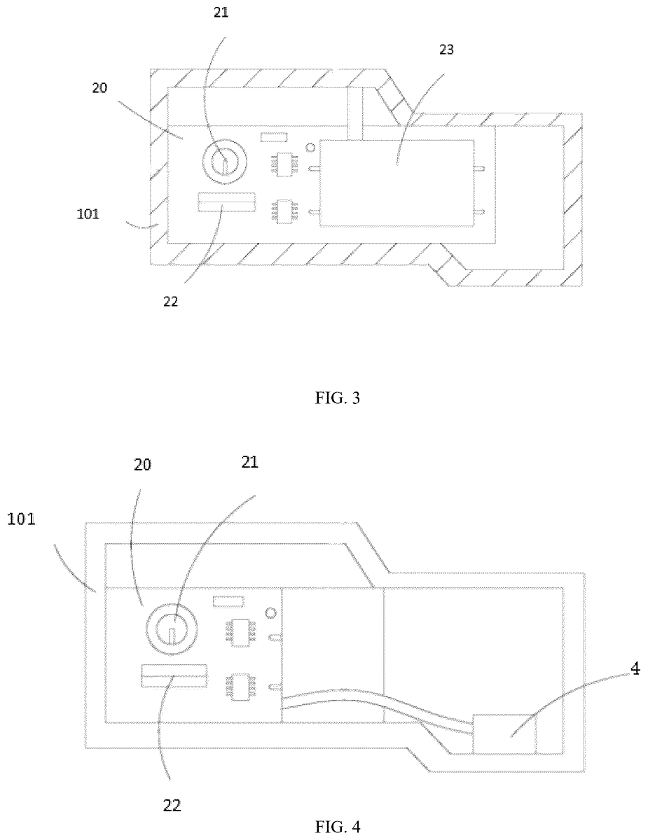

Referring to FIGS. 1 to 4, this embodiment discloses a module component for shoes and clothing, comprising a stitching piece 12, a connecting piece 11, a module 10, where the module 10 is connected to the stitching piece 12 by the connecting piece 11, the stitching piece 12 is connected on the shoes and clothing in a snap-fitted manner, and the module 10 is a luminous module or a vibration module. The stitching piece 12, the connecting piece 11, and the module 10 are provided on a sole, where the module 10 is connected to the stitching piece 12 with screws.

The luminous module includes a wrapping shell 101, a light strip 19, a circuit board 20, a control switch 21, a first charging port 22, and a first battery 23; the control switch 21 and the first charging port 22 are soldered onto the circuit board 20; an edge of the wrapping shell 101 is connected to the light strip 19; and the first battery 23 is electrically connected to the light strip 19. The light strip 19 is controlled by the external control switch 21 to emit and not emit light, and the first battery 23 for power supply is charged by the first charging port 22.

The vibration module includes the circuit board 20, the control switch 21, the first charging port 22, the first battery 23 and vibration units; the control switch 21 and the first charging port 22 are soldered onto the circuit board 20; and the first battery 23 is electrically connected to the vibration units.

At least two vibration units are provided. The vibration unit is controlled by the external control switch 21 to be turned on and off, and the first battery 23 for power supply is charged by the first charging port 22. The vibration unit is essentially a vibrator, which is implemented by a vibration motor. When in use, the luminous module or the vibration module is turned on and off by directly using the control switch 21. One of the luminous modules and the vibration module is used. A corresponding module 10 is selected and mounted onto the stitching piece 12 with screws, and then the stitching piece 12 is snapped into a stitching opening 13 to complete the connection of the module 10.

### Embodiment 2

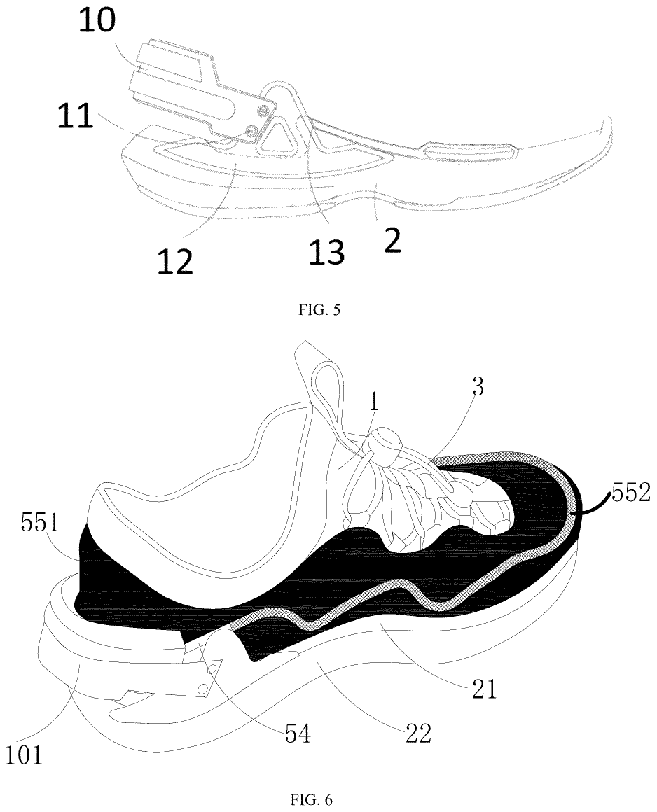

Referring to FIG. 5, this embodiment further discloses a sole component, comprising a sole 2, where the module component is provided at a heel of the sole 2. A stitching opening 13 is also provided on the sole 2, and the stitching piece 12 is connected onto the stitching opening 13 in a snap-fitted manner. The module 10 is any one of a luminous module and a vibration module. Various modules 10 make the shoes more distinctive and can give the shoes functions to meet the needs of consumers. The luminous module can meet nighttime reminding or aesthetic needs, while the vibration module can enhance the comfort of the customer. The module 10 may also be an inflation module 10. A micro gas pump is mounted in the wrapping shell 101, and a valve body is provided to control the output of the micro gas pump. An abutting opening is provided and connected to a gas delivery port of a bag body of the shoe upper 1. The control switch 21 makes the first battery 23 to supply power to the micro gas pump. The micro gas pump inputs gas into a corresponding bag body through a mouthpiece.

### Embodiment 3

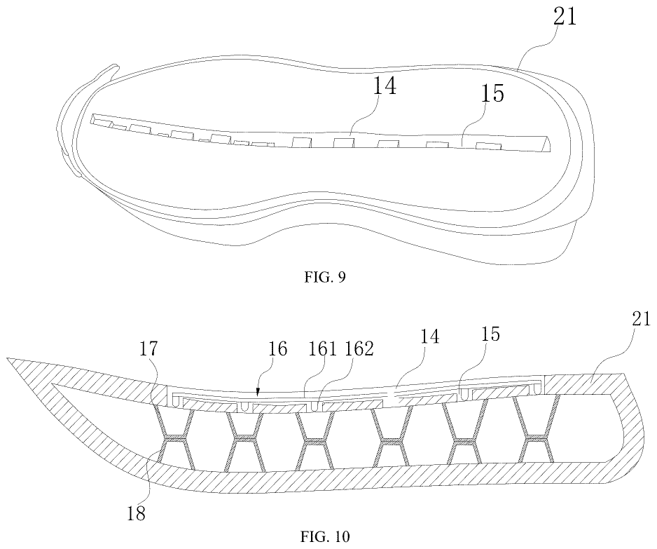

Referring to FIGS. 6 to 10, this embodiment provides luminous sports shoes, each of which includes: a shoe upper 1; a sole 2, where the shoe upper 1 is connected to the sole 2; an elastic module 3, where the elastic module 3 is provided on the shoe upper 1, and the elastic module 3 may be of a structure such as shoelaces or zippers.

The module component, where the module component is located at a heel of the sole 2; and a luminous component 5, comprising an optical fiber 54 connected to the module component. The luminous component 5 further includes a switch charging piece 51, a wire 52, a power supply chip piece 53, and the optical fiber 54 that are provided in the module component, where the switch charging piece 51 is electrically connected to the power supply chip piece 53 with the wire 52; the power supply chip piece 53 is electrically connected to the optical fiber 54; and the optical fiber 54 is fixed onto the shoe upper 1.

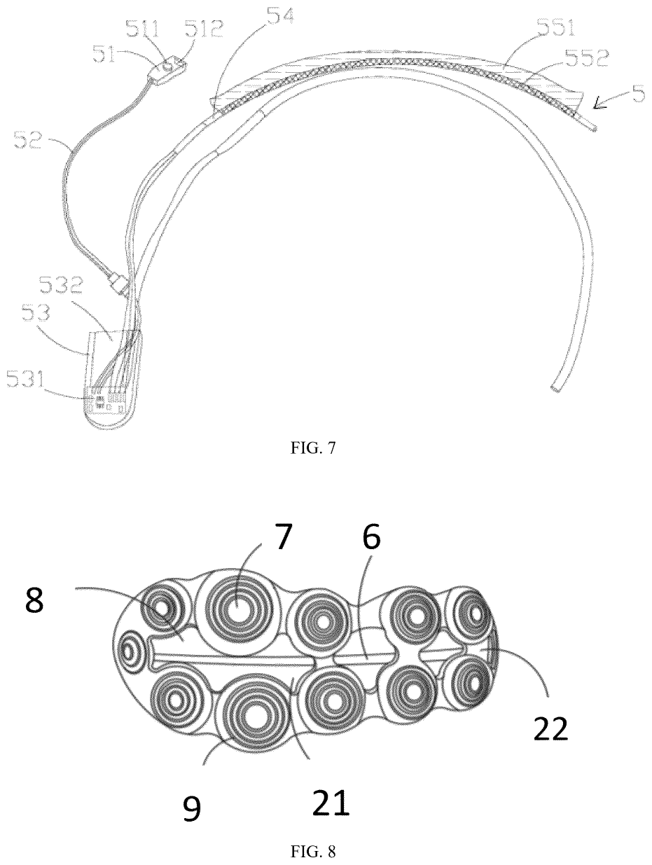

The switch charging piece 51 is electrically connected to the power supply chip piece 53 with the wire 52, and the power supply chip piece 53 is electrically connected to the optical fiber 54. The optical fiber 54 is made of an MMA +PTFE material, and the sole 2 is made of a TPU material, and therefore, the luminous sports shoes are comfortable to wear. The shoe upper 1 is provided with a densely woven region 551 and a sparse region 552, and the optical fiber 54 passes through the densely woven region 551 and the sparse region 552. Referring to FIG. 6, the densely woven region 551 and the sparse region 552 may serve as part of the shoe upper 1, and the optical fiber 54 is hidden in the densely woven region 551 and the sparse region 552. Referring to FIG. 7, the densely woven region 551 and the sparse region 552 can also wrap the optical fiber 54 and are connected to the shoe upper 1. Specifically, the densely woven region 551 is hidden in the shoe upper 1 in a wrapping manner, and the sparse region 552 is wound around an outer surface of the optical fiber 54. Yarn in the densely woven region 551 is denser, which can efficiently assist the optical fiber 54 in being connected to the shoe upper 1. Yarn in the sparse region 552 is relatively sparse, which not only influence the brightness of the optical fiber 54 when it emits light, but also can effectively limit the optical fiber 54. The sparse region 552 is distributed in a mesh pattern on the outer surface of the optical fiber 54, so that the wrapping strength is high.

The switch charging piece 51 is provided with a switch button 511 and a second charging port 512, which facilitates the control of turning on the luminous component 5, so that the optical fiber 54 emits light. One end of a USB connector is inserted into the second charging port 512 for charging. The power supply chip piece 53 is provided with a control chip 531 and a second battery 532, and a sealing plug is provided on the second charging port 512 for waterproof sealing. The second charging port 512 converts electrical energy into chemical energy and stores the chemical energy in the second battery 532 via a data cable; and the second battery 532 converts the chemical energy into electrical energy to power on the optical fiber 54 to emit light. A circuit in the control chip 531 can implement and control flash and gradient operations, while multiple colors can also be set. One optical fiber 54 is provided, and an entire optical fiber 54 is provided around the edge of the sports shoe, which has strong aesthetics. The power supply chip piece 53 is placed in the wrapping shell 101, and the switch charging piece 51 is placed in the wrapping shell 101 of a shoe body. It can be turned on directly by pressing, and when the switch charging piece 51 needs to be charged, it is necessary to take it out of the wrapping shell 101 for charging.

The sole 2 includes:
A midsole 21, connected to the shoe upper 1, where the midsole 21 is hollow inside and is of a transparent material, a luminous strip 6 is provided in the midsole 21, a plurality of upper protrusions 17 and a plurality of lower protrusions 18 are provided in the midsole 21, the upper protrusions 17 is opposite to the lower protrusions 18, and the protrusions are connected; and
An outsole 22, provided at a bottom of the midsole 21, where the bottom of the outsole 22 is provided with a plurality of damping protrusions 7, and the outsole 22 is provided with a plurality of irregular-shaped holes 8. The luminous strip 6 is turned on, and is set to be in a streamer mode, the midsole 21 made of the transparent material can enlarge a luminous range by refraction due to the plurality of upper protrusions 17 and lower protrusions 18 provided inside, and the midsole 21 is exposed in combination with the plurality of irregular-shaped holes 8 provided in the outsole 22 to expand the luminous range. Thus, the shoes may be more eye-catching at night, and the aesthetics of the shoes is enhanced. Then, a very good damping effect is exerted by the damping protrusions 7 provided on the outsole 22 in combination with the upper protrusions 17 and the lower protrusions 18 inside the midsole 21, which can increase the practicality of the shoes. The luminous strip 6 is an LED light strip 19. Energy sources can be saved, and the brightness is higher. The damping protrusion 7 is circular or elliptical. While the aesthetics is enhanced, a very good damping effect can be exerted, so that both feet feel smooth and soft when touching the ground. A surface of the damping protrusion 7 is provided with a plurality of grooves 9. The skid resistance of the sole 2 is increased. The luminous strip 6 is provided in a straight line from a forefoot to a heel of the midsole 21. An entire sole 2 can be made shiny, which makes the shoes more eye-catching at night.

The sole 2 is provided with a stitching piece 12, a connecting piece 11, and a module 10. The module 10 is connected to the stitching piece 12 by the connecting piece 11. The sole 2 is also provided with a stitching opening 13, and the stitching piece 12 is connected to the stitching opening 13 in a snap-fitted manner. The module 10 is a luminous module and a vibration module. The luminous module includes a wrapping shell 101, an edge of the wrapping shell 101 is connected to the optical fiber 54; and the optical fiber 54 is electrically connected to the power supply chip piece 53 with the wire 52. The vibration module includes the wrapping shell 101. Vibration units are provided in the wrapping shell 101. The vibration unit is electrically connected to the power supply chip with the wire 52. Various modules 10 make the shoes more distinctive. When in use, the luminous module or the vibration module is turned on and off by directly controlling the external switch. One of the luminous modules and the vibration module is used. A corresponding module 10 is selected and mounted onto the stitching piece 12 with screws, and then the stitching piece 12 is snapped into a stitching opening 13 to complete the connection of the module 10.

A surface of the midsole 21 is further provided with a mounting groove (14), a plurality of communication grooves 15 communicated with the interior of the midsole (21) are provided in the mounting groove 14, and a light bar 16 connected to the power supply chip piece 53 is provided in the mounting groove 14. The light bar 16 includes a bar body 161 and a plurality of light beads 162 spaced on the bar body 161, and each of the light beads 162 is located in a corresponding communication groove 15. All the communication grooves 15 are spaced, and the corresponding light beads 162 are also distributed in a spaced manner, thus avoiding that the plurality of light beads 162 are too close to cause local light rays to be too strong. The specific spacing distance is set according to the actual situation, and the specific number of the light beads 162 can be set according to the actual situation as well as the specific number of the communication grooves 15. The shape of the mounting groove 14 can be designed to be in a shape of a straight line or curve. When the mounting groove 14 is in the shape of the straight line, the number of the corresponding light beads 162 is more and the distribution area is wider, and thus, light rays in an entire light guide chamber are more uniform. However, costs are higher. Therefore, the mounting groove 14 in this embodiment are still in the shape of the linear line. To improve the luminous effect of the light bar 16, each light bead 162 can be set to emit light of different colors, and thus, different colors of light can be seen outside the sole 2.

The foregoing is only a preferred embodiment of the present application and is not used to limit the present application, and any modifications, equivalent replacements, improvements, etc., made within the spirit and principles of the present application shall be included in the scope of protection of the present application.

What is claimed is:

1. A module component for shoes and clothing, comprising a stitching piece (12), a connecting piece (11), and a module (10), wherein the module (10) is connected to the stitching piece (12) by the connecting piece (11), the stitching piece (12) is connected onto the shoes and clothing in a snap-fitted manner; the module (10) is selected from the group consisting of luminous module and a vibration module; the luminous module comprises a wrapping shell (101), a light strip (19), a circuit board (20), a control switch (21), a first charging port (22), and a first battery (23); the control switch (21) and the first charging port (22) are soldered onto the circuit board (20); an edge of the wrapping shell (101) is connected to the light strip (19); and the first battery (23) is electrically connected to the light strip (19).

2. (canceled)

3. The module component for shoes and clothing according to claim 1, wherein the vibration module comprises the circuit board (20), the control switch (21), the first charging port (22), the first battery (23) and vibration units; the control switch (21) and the first charging port (22) are soldered onto the circuit board (20);
and the first battery (23) is electrically connected to the vibration units.

4. A sole component, comprising a sole (2), wherein the module component according to claim 1 is provided at a heel of the sole (2).

5. Luminous sports shoes, wherein each luminous sports shoe comprises:
a shoe upper (1);
a sole (2), the shoe upper (1) being connected to the sole (2);
an elastic module (3), provided on the shoe upper (1);
the module component according to claim 1, located at a heel of the sole (2); and
a luminous component (5), comprising an optical fiber (54) connected to the module component.

6. The luminous sports shoes according to claim 4, wherein the luminous component (5) further comprises a switch charging piece (51), a wire (52), a power supply chip piece (53), and the optical fiber (54) that are provided in the module component; the switch charging piece (51) is electrically connected to the power supply chip piece (53) with the wire (52); the power supply chip piece (53) is electrically connected to the optical fiber (54); and the optical fiber (54) is fixed onto the shoe upper (1).

7. The luminous sports shoes according to claim 5, wherein the shoe upper (1) is provided with a densely woven region (551) and a sparse region (552), and the optical fiber (54) passes through the densely woven region (551) and the sparse region (552).

8. The luminous sports shoes according to claim 6, wherein the sparse region (552) is distributed in a mesh pattern on an outer surface of the optical fiber (54).

9. The luminous sports shoes according to claim 5, wherein the switch charging piece (51) is provided with a switch button (511) and a second charging port (512).

10. The luminous sports shoes according to claim 8, wherein the control chip piece (53) is provided with a control chip (531) and a second battery (532); the second charging port (512) converts electrical energy into chemical energy and stores the chemical energy in the second battery (532) via a data cable; and the second battery (532) converts the chemical energy into electrical energy to power on the optical fiber (54) to emit light.

11. The luminous sports shoes according to claim 4, wherein at least one optical fiber (54) is provided.

12. The luminous sports shoes according to claim 4, wherein an entire optical fiber (54) is provided around an edge of the sports shoe.

13. The luminous sports shoes according to claim 4, wherein the sole (2) comprises:
a midsole (21), connected to the shoe upper (1), the midsole (21) being hollow inside and being of a transparent material, a luminous strip (6) connected to a power supply chip piece (53) being provided in the midsole (21), a plurality of upper protrusions (17) and a plurality of lower protrusions (18) being provided in the midsole (21), the upper protrusions (17) being opposite to the lower protrusions (18), and the protrusions being connected; and
an outsole (22), provided at a bottom of the midsole (21), the bottom of the outsole (22) being provided with a plurality of damping protrusions (7), and the outsole (22) being provided with a plurality of irregular-shaped holes (8).

14. The luminous sports shoes according to claim 12, wherein the damping protrusion (7) is circular or elliptical.

15. The luminous sports shoes according to claim 13, wherein surfaces of the damping protrusions (7) are each provided with a plurality of grooves (9).

16. The luminous sports shoes according to claim 12, wherein the luminous strip (6) is provided in a straight line from a forefoot to a heel of the midsole (21).

17. The luminous sports shoes according to claim 12, wherein a surface of the midsole (21) is further provided with a mounting groove (14), a plurality of communication grooves (15) communicated with the interior of the midsole (21) are provided in the mounting groove (14), and a light bar (16) connected to the power supply chip piece (53) is provided in the mounting groove (14).

18. The luminous sports shoes according to claim 16, wherein the light bar (16) comprises a bar body (161) and a plurality of light beads (162) spaced on the bar body (161), and each of the light beads (162) is located in a corresponding communication groove (15).

19. The luminous sports shoes according to claim 17, wherein at least two light beads (162) have different luminous colors.
